(19) United States
(12) Patent Application Publication
(10) Pub. No.: US 2002/0131582 A1
(43) Pub. Date: Sep. 19, 2002

(54) Method and system for noise cancellation in communication terminal

(76) Inventor: Arthur Oosterveen, Enschede (NL)

Correspondence Address: Spencer C. Patterson, Esq., Jenkens & Gilchrist, P.C., Suite 3200, 1445 Ross Avenue, Dallas, TX, 75202-2799, US

(21) Appl. No.: 09/812,132

(22) Filed: Mar. 19, 2001

(51) Int. Cl. H04M 9/08

(52) U.S. Cl. 379/406.01

(57) ABSTRACT

Method and system are disclosed for canceling ambient noise in a communication terminal. A buzzer serves a dual role both as a ringer for incoming calls or other such event notifications and also as a transducer for transducing the ambient noise into electro-acoustic signals. The electro-acoustic signals from the buzzer undergo phase inversion and are then combined with the non-inverted signals from a microphone. The inverted and non-inverted phases of the ambient noise electro-acoustic signals substantially cancel each other when combined, leaving essentially only the desired speech signals.

### BACKGROUND OF THE INVENTION

1. Field of the Invention

The present invention is related to noise cancellation and, more particularly, to a method and system for canceling ambient noise in a communication terminal.

2. Description of the Related Art

Ambient or background noise can distort or otherwise interfere with the intended speech or voice signals 10 transmitted over a communication terminal. Therefore, cancellation of ambient or background noise continues to be a goal of communication terminal designers.

One common method of canceling the ambient noise in a communication terminal is to use a noise canceling microphone. Referring to FIG. 1, a typical noise canceling microphone 100 has two ports or openings 10 and 12 through which sound may be received. The microphone 100 is mounted in the communication terminal in such a way that speech may be received only through the first port 10, while ambient noise may be received through both the first port 10 and the second port 12. In operation, the first and second ports 10 and 12 conduct the received ambient noise to opposite sides 14a and 14b of a transducer 14. Because the same ambient noise impinges opposite sides of the transducer 14, the noise signals substantially cancel each other. Thus, only the intended speech signals remain.

For the noise canceling microphone 100 to be effective, however, the speech source (e.g., the user's mouth) must be positioned in close proximity to the microphone 100. Otherwise, the intended speech may be picked up in the second port 12 also and thereby be canceled along with the ambient noise. Such close proximity may not be practical for handheld communication terminals such as mobile stations, personal digital assistants, and similar communication terminals due to their small physical dimensions. For example, some communication terminals simply are too small for the microphone to be positioned near the user's mouth during operation. Moreover, some communication terminals are designed such that the microphone is not located at either end of the communication terminal, but somewhere toward the middle.

Where the microphone cannot be positioned close to the speech source, another common method of canceling noise is to use two separate microphones, as illustrated in FIG. 2. In FIG. 2, a first microphone 20 is positioned some distance away from a speech source 22, but still within an appreciable range of the direct sounds therefrom. The term “direct sound” as used herein is generally understood to be the acoustic signals that are received directly from the speech source and at an appreciable level, as opposed to reflected signals or signals received from some other source. A second microphone 24 is used for noise canceling and is located away from the first microphone 20 effectively outside the range of the direct sounds from the speech source. Thus, the second microphone 24 can only pick up diffused sounds or ambient noise.

In operation, the diffused sounds are received and transduced by the second microphone 24 into electro-acoustic signals that are then subjected to phase inversion. These signals are then combined with the electro-acoustic signals from the first microphone 20, which have not been inverted. The term “phase inversion” as used herein means the shifting of the phase of a signal either positively or negatively by about 180 degrees. Details of the phase inversion process are well known and, therefore, will not be explained further herein. It is suffice to say that when the inverted and non-inverted phases of the diffused sound electro-acoustic signals are combined, they substantially cancel each other, leaving only the desired speech signals. A summing node 26 represents the point where combining of the signals occur.

In some cases, however, even the method of FIG. 2 may not be economical or practical because a second microphone can increase the cost of the communication terminal as well as take up valuable space therein. Thus, it is desirable to be able to provide a practical and economical way to cancel the ambient noise in a communication terminal, and to be able to do so without adding substantial cost thereto or taking up extra space therein.

### SUMMARY OF THE INVENTION

The present invention is directed to a method and system for canceling ambient noise in a communication terminal. A buzzer serves a dual role both as a ringer for incoming calls or other such event notifications and also as a transducer for transducing the ambient noise into electro-acoustic signals. The electro-acoustic signals from the buzzer undergo phase inversion and are then combined with the non-inverted signals from a microphone. The inverted and non-inverted phases of the ambient noise electro-acoustic signals substantially cancel each other when combined, leaving essentially only the desired speech signals.

In general, in one aspect, the invention is directed to a method of canceling noise in a communication terminal. The method comprises the steps of mounting a transducer in the communication terminal, the transducer providing audio notification for at least one predetermined event occurring in the communication terminal, inverting a phase of an ambient noise electro-acoustic signal generated by the transducer, and combining the inverted phase electro-acoustic signal with an electro-acoustic signal generated by a microphone mounted in the communication terminal.

In general, in another aspect, the invention is directed to a noise canceling system for a communication terminal. The system comprises a transducer mounted in the communication terminal, the transducer providing audio notification for at least one predetermined event occurring in the communication terminal, a phase inversion unit connected to the transducer for inverting a phase of an ambient noise electro-acoustic signal generated by the transducer, and a summing node connected to the phase inversion unit for combining the inverted phase electro-acoustic signal with an electro-acoustic signal generated by a microphone mounted in the communication terminal.

It should be emphasized that the term “comprises/ comprising” when used in this specification is taken to specify the presence of stated features, integers, steps or components, but does not preclude the presence or addition of one or more other features, integers, steps, components or groups thereof.

### BRIEF DESCRIPTION OF THE DRAWINGS

A more complete understanding of the method and apparatus of the present invention may be had by reference to the detailed description in conjunction with the following drawings, wherein:

FIG. 1 illustrates a prior art noise canceling microphone;

FIG. 2 illustrates a prior art noise canceling microphone system;

FIG. 3 illustrates a communication terminal according to one embodiment of the present invention;

FIG. 4 illustrates a functional block diagram according to one embodiment of the present invention;

FIG. 5 illustrates a functional block diagram according to another embodiment of the present invention; and

FIG. 6 illustrates a method according to one embodiment of the present invention.

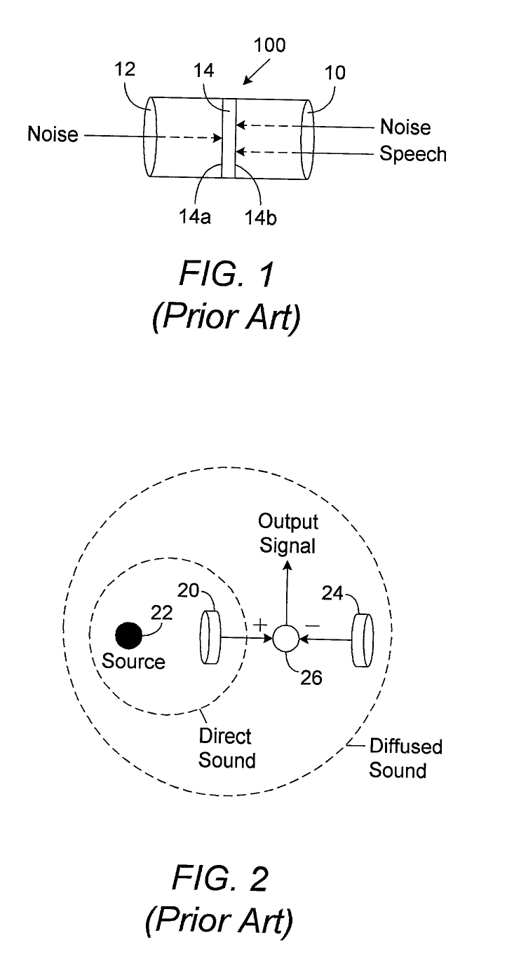

### DETAILED DESCRIPTION OF THE EXEMPLARY PREFERRED EMBODIMENTS

Following is a detailed description of the exemplary preferred embodiments of the present invention with reference to the drawings, wherein reference numerals for the same or similar components are carried forward.

As mentioned above, the communication terminal of the present invention uses a buzzer both as a ringer for incoming calls and also as a transducer for transducing ambient noise into electro-acoustic signals. Such an arrangement has an advantage in that additional components such as a second microphone are not required because the buzzer is an already existing component in the communication terminal. Thus, little or no additional cost need be added to the expense of manufacturing the communication terminal, and little or no extra space need be taken up therein. Furthermore, the layout of most communication terminals is such that the buzzer is almost always positioned sufficiently far away from the microphone and outside the range of the direct sounds from a speech source as to avoid unwanted canceling of the speech signals therefrom.

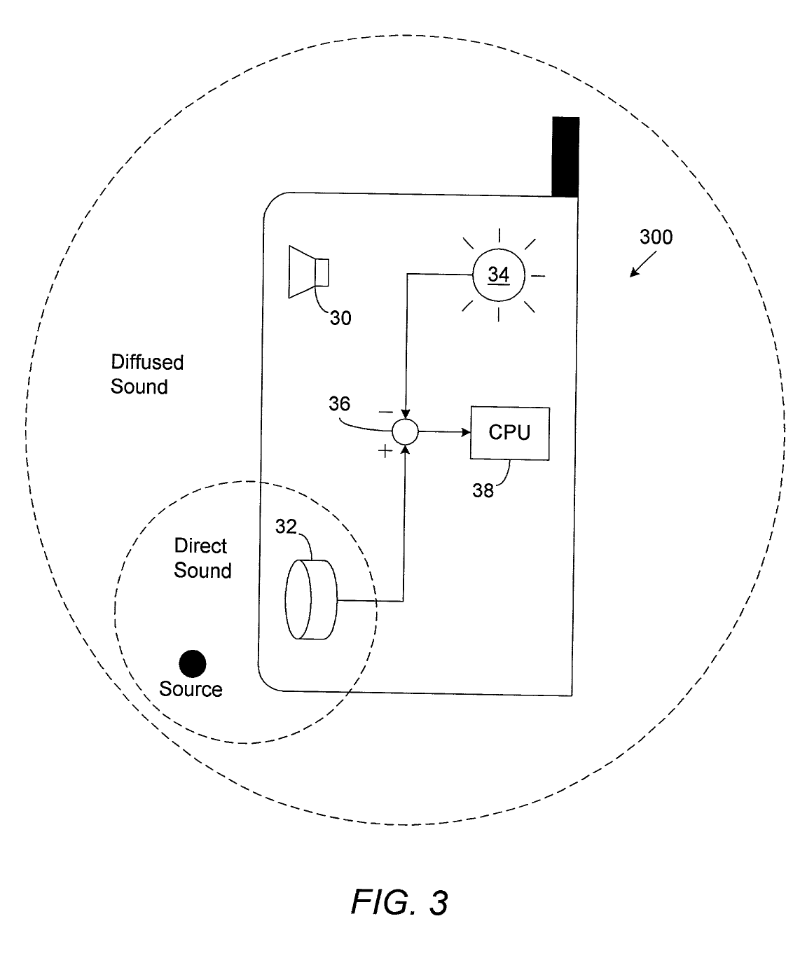

Referring now to FIG. 3, a communication terminal according to one embodiment of the present invention is shown at 300. The communication terminal 300 has a number of standard components including an audio speaker 30 that allows the speech received from a communicating party to be heard at the communication terminal 300. The communication terminal 300 further includes a microphone 32 for receiving and transducing into electro-acoustic signals any direct sounds from a speech source as well as any diffused sounds present in the general vicinity of the communication terminal 300.

A buzzer 34 is configured to function as a ringer for notifying the user of incoming calls and other such events in the communication terminal 300. Examples of the buzzer 34 may include a piezoelectric buzzer, a magnetic buzzer, a dynamic buzzer, other presently available buzzers, or yet to be developed buzzers. The buzzer 34 is also configured to function as a transducer for transducing any diffused sounds in the general vicinity of the communication terminal 300 into electro-acoustic signals. Such signals may then be processed or otherwise used for canceling ambient noise in accordance with the principles of the present invention.

In a preferred embodiment, the buzzer 34 is located in the communication terminal 300 at a location away from the microphone 32 and outside the range of the direct sounds from the speech source, as shown. Thus, only the microphone 32 can receive any appreciable levels of direct sounds from the speech source, whereas the buzzer 34 can only receive the diffused sounds or ambient noise.

In operation, the diffused sounds are received and transduced by the buzzer 34 into electro-acoustic signals. The electro-acoustic signals transduced by the buzzer 34 are then subjected to phase inversion (as will be explained herein) and combined with the non-inverted electro-acoustic signals from the microphone 32. A summing node 36 represents the point where the signals are combined. The combination of the two signals causes the inverted and non-inverted phases to substantially cancel each other, leaving essentially only the desired speech signals as the output signal from the summing node 36. The speech signals are thereafter processed (e.g., encoded, encrypted, transmitted) by a central processing unit 38 according to well known techniques.

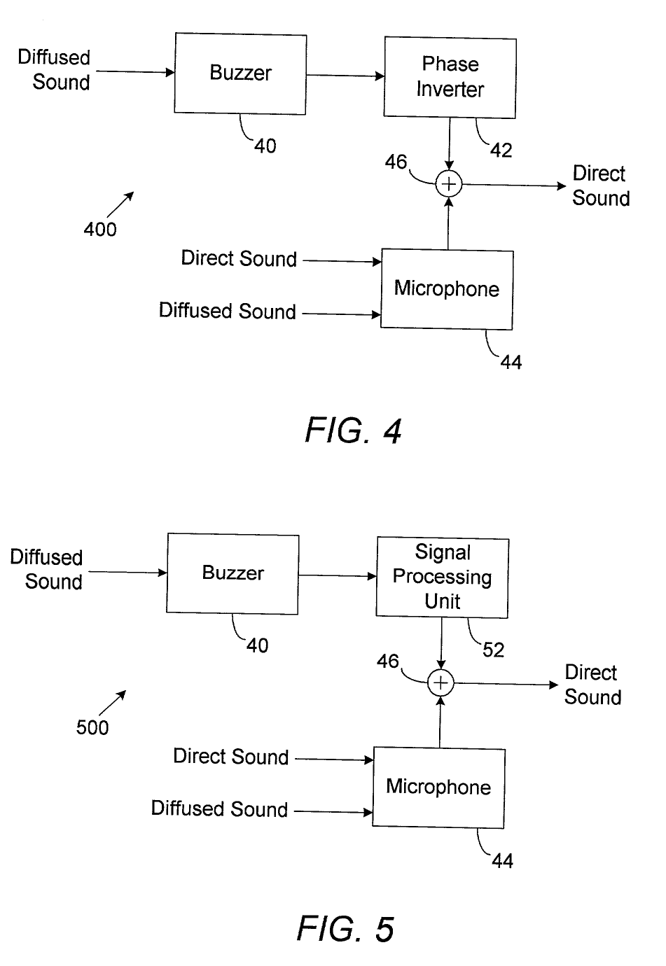

Referring now to FIG. 4, a functional block diagram of a pertinent portion 400 of a communication terminal according to one embodiment of the present invention is shown. The portion 400 of the communication terminal includes a buzzer 40, a phase inverter 42, a microphone 44 and a summing node 46. As before, diffused sounds in the general vicinity of the communication terminal are received and transduced by the buzzer 40 into electro-acoustic signals. The phase inverter 42 thereafter inverts the phase of the electro-acoustic signals so that they are essentially 180 degrees out of phase relative to the originally received signals. At about the same time, both direct and diffused sounds are also transduced by the microphone 44 into electro-acoustic signals. The inverted signals from the phase inverter 42 and the signals from the microphone 44 are subsequently summed at the summing node 46. The combination causes the inverted and non-inverted diffused sound electro-acoustic signals to substantially cancel each other, leaving essentially only the direct sounds electro-acoustic signals.

In some embodiments, the communication terminal may employ a signal processing unit, a software application, or a combination thereof instead of the phase inverter 42 to invert the phase of the diffused sound electro-acoustic signal. Such an embodiment can be seen in FIG. 5, where a functional block diagram of a pertinent portion 500 of a communication terminal is shown. The embodiment of FIG. 5 is essentially the same as the embodiment of FIG. 4 except the phase inverter 42 has been replaced by a signal processing unit 52.

The signal processing unit 52 may be any suitable signal processing unit such as a digital signal processor (DSP), a microprocessor, a digital filter, or the like, along with any circuitry and/or software applications associated therewith. In operation, the signal processing unit 52 functions to invert the phase of the electro-acoustic signals generated by the buzzer 40. The inverted signals are thereafter used to cancel the diffused sounds in the manner described above. It is contemplated that using the signal processing unit 52 instead of the phase inverter 42 may improve the noise cancellation by virtue of the enhanced performance expected from such signal processing units. However, either one or the other may certainly be used depending on the particular needs of the application without departing from the scope of the invention.

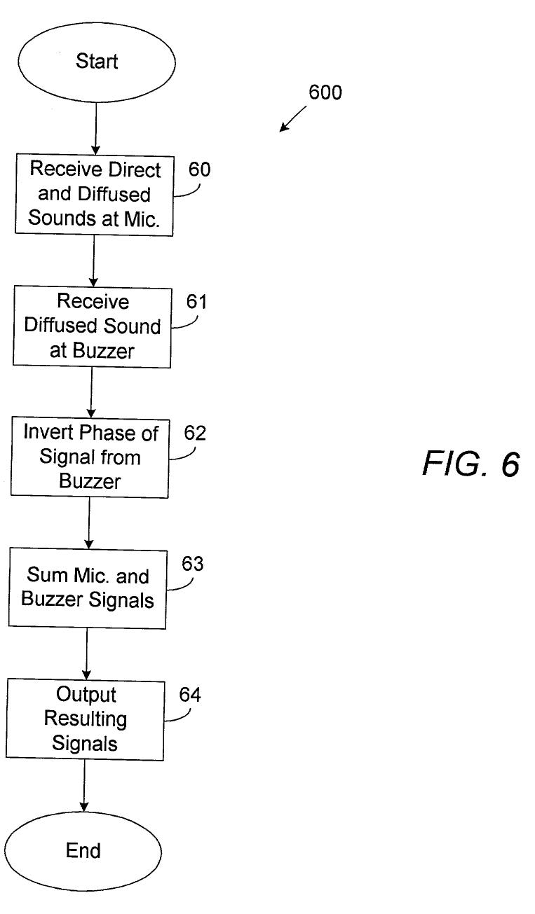

FIG. 6 illustrates a method 600 in accordance with one embodiment of the present invention. At step 60, direct and diffused sounds are received at a microphone and converted into electro-acoustic signals. Diffused sounds are also received and converted at a buzzer at step 61. The phase of the diffused sound electro-acoustic signal generated by the buzzer are inverted at step 62. At step 63, the electro-acoustic signals from the microphone and the buzzer are summed together, e.g., via a summing node. The difference in phase causes the inverted and non-inverted signals to substantially cancel each other, leaving essentially only the direct sounds. The resulting signal is outputted at step 64.

Although various embodiments of the invention have been shown and described, it will be appreciated by those skilled in the art that changes may be made to these embodiments without departing from the principles and the spirit of the invention, the scope of which is defined in the appended claims.

What is claimed is:

1. A method of canceling noise in a communication terminal, comprising the steps of:
mounting a transducer in said communication terminal, said transducer providing audio notification for at least one predetermined event occurring in said communication terminal;
inverting a phase of an ambient noise electro-acoustic signal generated by said transducer; and
combining said inverted phase electro-acoustic signal with an electro-acoustic signal generated by a microphone mounted in said communication terminal.

2. The method according to claim 1, wherein said transducer is a buzzer and said predetermined event is an incoming call.

3. The method according to claim 1, wherein said transducer is mounted in said communication terminal such that little or no direct sound from a speech source will be received thereby.

4. The method according to claim 1, wherein said phase inversion is performed using a phase inverter.

5. The method according to claim 1, wherein said phase inversion is performed using a digital signal processor.

6. A noise canceling system for a communication terminal, comprising:
a transducer mounted in said communication terminal, said transducer providing audio notification for at least one predetermined event occurring in said communication terminal;
a phase inversion unit connected to said transducer for inverting a phase of an ambient noise electro-acoustic signal generated by said transducer; and
a summing node connected to said phase inversion unit for combining said phase inverted electro-acoustic signal with an electro-acoustic signal generated by a microphone mounted in said communication terminal.

7. The system according to claim 6, wherein said transducer is a buzzer and said predetermined event is an incoming call.

8. The system according to claim 6, wherein said transducer is mounted in said communication terminal such that little or no direct sound from a speech source will be received thereby.

9. The system according to claim 6, wherein said phase inversion unit includes a phase inverter.

10. The system according to claim 6, wherein said phase inversion unit includes a digital signal processor.
